(19) United States
(12) Patent Application Publication
(10) Pub. No.: US 2010/0044020 A1
(43) Pub. Date: Feb. 25, 2010

(54) HYDROGEN GAS-COOLING DEVICE

(76) Inventor: Nobuyuki Kojima, Kawasaki-shi (JP)

Correspondence Address: NIXON & VANDERHYE, PC, 901 NORTH GLEBE ROAD, 11TH FLOOR, ARLINGTON, VA, 22203, US

(21) Appl. No.: 12/596,496

(22) PCT Filed: Mar. 31, 2008
(86) PCT No.: PCT/JP2008/056389

§ 371 Date: Oct. 19, 2009

(30) Foreign Application Priority Data
Apr. 20, 2007 (JP) 2007-111562

(51) Int. Cl. F28D 7/10; F17C 5/06

(52) U.S. Cl. 165/154; 141/82

(57) ABSTRACT

A hydrogen gas-cooling device of the present invention includes, a heat exchanger that perform beat exchange between a hydrogen gas and a liquefied gas to cool a hydrogen gas; and a head tank that stores the liquefied gas supplied to the heat exchanger, wherein the heat exchanger has double pipe structure in which the hydrogen gas flows in an inner pipe, an outer pipe is filled with the liquefied gas, the pipe axis of the double pipe structure is vertically or obliquely arranged, a liquefied gas supply pipe that supplies the liquefied gas from the head tank is connected to a bottom part of the outer tube, and a return pipe that returns the liquefied gas to the head tank is provided at a position upper than that of the bottom part of the outer pipe.

### TECHNICAL FIELD

The present invention relates to a hydrogen gas-cooling device that is used to cool a hydrogen gas to be supplied to a hydrogen automobile, etc.

Priority is claimed on Japanese Patent Application No. 2007-111562, filed Apr. 20, 2007, the content of which is incorporated herein by reference,

### BACKGROUND ART

In a hydrogen automobile, it is required to fill a fuel tart with a hydrogen gas with a high pressure. When a fuel tank is filled with a hydrogen gas) the increase in the temperature occurs due to adiabatic compression. Moreover, a hydrogen gas is different from other conventional gases, and has the property that the adiabatic compression thereof causes the increase in the temperature due to Joule-Thomson effect.

When the supply flow rate of a hydrogen gas is set high in order to improve the efficiency of filling operation, it is required to cool a hydrogen gas to a range from −30° C. to −40° C. before filling a fuel tank because the temperature of a hydrogen gas is likely to increase.

Examples of a hydrogen gas-cooling device used in the aforementioned purpose include the device proposed in Japanese Unexamined Patent Application, First Publication No. 2005-83567.

This cooling device includes a heat exchanger with the structure in which a cooled cooling pipe is immersed in a refrigerant tank that stores and circulates a refrigerant such as brine Hydrogen to be cooled is allowed to flow in the cooling pipe, and cooled.

In addition, there is known another type of cooling device in which a liquefied gas such as liquid nitrogen is used as a refrigerant, and supplied and stored in a refrigerant tank.

However, in the aforementioned hydrogen gas-cooling device, there are problems in that the overall facilities are enlarged, the consumption quantity of a refrigerant that is liquid nitrogen increases, and the starting time and the termination time are elongated.

[Patent Document 1]

Japanese Unexamined Patent Application, First Publication No. 2005-83567

### DISCLOSURE OF INVENTION

### Problems to be Solved by the Invention

An object of the present invention is to provide a hydrogen-gas cooling device that can downsize facilities, reduce the consumption quantity of a refrigerant such as liquid nitrogen, and shorten the starting time and the termination time of the device.

### Means to Solve the Problems

In order to achieve the aforementioned objects,

the present invention provides a hydrogen gas-cooling device including:

a heat exchanger that perform heat exchange between a hydrogen gas and a liquefied gas to cool a hydrogen gas; and a head tank that stores the liquefied gas supplied to the heat exchanger, wherein

the heat exchanger has double pipe structure in which the hydrogen gas flows in an inner pipe, an outer pipe is filled with the liquefied gas, the pipe axis of the double pipe structure is vertically or obliquely arranged, a liquefied gas supply pipe that supplies the liquefied gas from the head tank is connected to a bottom part of the outer pipe, and a return pipe that returns the liquefied gas to the head tank is provided at a position upper than the bottom part of the outer pipe, and

the bottom part of the head tank is positioned upper than a top part of the heat exchanger.

In the present invention, it is preferable that two or more of the return pipes be provided at different positions in a vertical direction of the outer pipe.

Also, in the present invention, it is preferable that a part of the outer pipe of the heat exchanger form bellows

Also, in the present invention, it is preferable that a bypass pipe be provided in parallel with the inner pipe of the heat exchanger.

### EFFECT OF THE INVENTION

According to the present invention, with the cooling of a hydrogen gas within the heat exchanger, a part of the liquefied gas within the outer pipe is evaporated, and the overall apparent density decreases. Therefore, the evaporated liquefied gas is spontaneously moved upward, and the liquefied gas is spontaneously circulated between the heat exchanger and the head tank. In this way, the liquefied gas is always moved within the overall outer pipe, resulting in the increase in the film heat-transfer coefficient on the side of the liquefied gas and the decrease in the necessary heat-transfer area. Accordingly, the heat transfer can be downsized, and the power for the supply of the liquefied gas is unncessary. In addition, the heat loss in the steady state is small, and therefore, the consumption quantity of the liquefied gas can be reduced.

By using the heat exchanger with the double pipe structure, the spacing between the outer pipe and the inner pipe therein can be shortened to for example about 20 mm. Therefore, the hold-up quantity (i.e. stored quantity) of the liquefied gas can be reduced to about 10-20 liters, and it is possible to shorten the time for the preparation of the liquefied gas during the start and the times for the discharge and beating when the liquefied gas is cleared off after the end of the operation.

In addition, by forming bellows in a part of the outer pipe, it is possible to cancel the elongation and contraction of the outer pipe and the inner pipe in the case of the temperature change of the heat exchanger

Furthermore, by providing two or more of the return pipes at different positions in a vertical direction of the outer pipe, it is possible to change effective heat-transfer area according to need, to thereby control the temperature of the hydrogen gas at the exit of the heat exchanger. In addition, by providing the bypass pipe to mix the uncooled hydrogen gas with the cooled hydrogen gas, it is possible to control the temperate of the cooled hydrogen gas.

### BRIEF DESCRIPTION OF THE DRAWINGS

FIG. 1 is a schematic diagram representing an example of the hydrogen-cooling device of the present invention.

### DESCRIPTION OF THE REFERENCE SYMBOLS

1 represents a heat exchanger, 2 represents all outer pipes 3 represents an inner pipe, 4 represents bellows, 5 represents a head tank, 6 represents a liquefied gas supply pipe, 7 represents a return pipe, 9 represents an on-off valve, 9 represents a main return pipe, and 21 represents a bypass pipe.

### BEST MODE FOR CARRYING OUT THE INVENTION

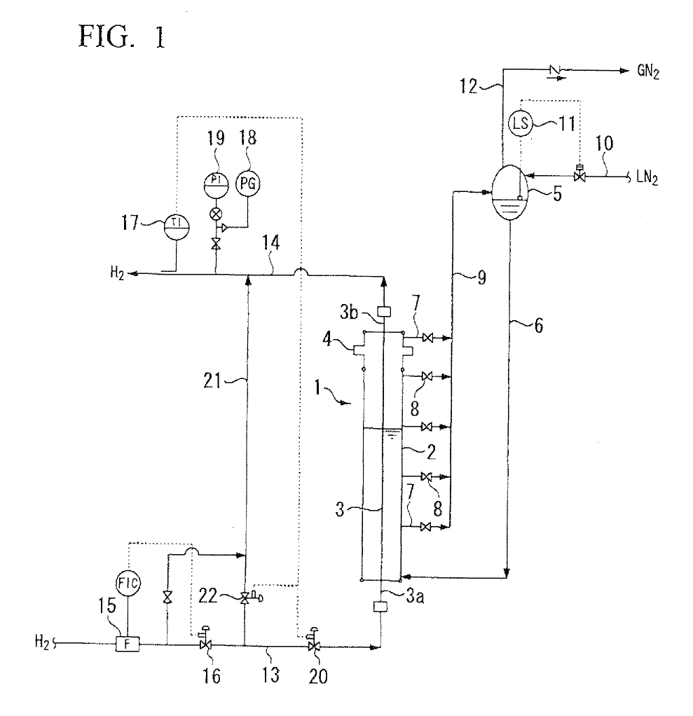

FIG. 1 represents an example of the hydrogen-cooling device of the present invention. In FIG. 1, the reference symbol 1 represents the heat exchanger. This heat exchanger 1 has the double pipe structure formed of the straight pipe-shaped outer pipe 2 and the straight pipe-shaped inner pipe 3 that is coaxially provided within the outer pipe 2.

This heat exchanger 1 is positioned in the sanding state in which the axes of the outer pipe 2 and the inner pipe 3 are arranged vertically or in the direction that is slightly tilted from the vertical direction.

The outer pipe 2 has the function of storing the liquefied gas therein which acts as a refrigerant such as liquid nitrogen, and is formed of a stainless steal with an inner diameter of 40-60 mm, an outer diameter of 45-80 mm, and a length of 500-2,000 mm The upper pact of his outer pipe 2 forms the bellows 4 that can elongate and contract in the longitudinal direction. Herein, the position of this bellows 4 is not limited to the upper part, and can be any position of the outer pipe 2.

The top par and the bottom part of the outer pipe 2 are closed. The outside of the outer pipe 2 is covered with an adiabatic material, which is not illustrated, so as to prevent the transfer of beat from the outside to the liquefied gas.

The inner pipe 3 has the function of flowing a hydrogen gas to be cooled herein, and is formed of a metal material, such as SUS316L, with an inner diameter of 2-10 mm, an outer diameter of 10-30 mm, and a length of 500-2,000 mm. The metal material has the resistance to low-temperature hydrogen embrittlement. The inner pipe 3 penetrates the top part and the bottom part of the outer pipe 2, and the penetrating upper part and lower part form the exit port 3b and the entrance port 3a, respectively.

In addition, the reference symbol 5 represents the head tank that stores the liquefied gas such as liquid nitrogen. This head tank 5 is provided at the position upper than the top part of the heat exchanger 1, and preferably at the position that is about 30-50 cm upper than the top part of the heat exchanger 1.

The bottom part of the head tank 5 and the bottom part of the outer pipe 2 of the heat exchanger 1 are connected through the liquefied gas supply pipe 6, and the liquefied gas is flowed down and supplied from the head tank 5 into the outer pipe 2 through the difference in height.

The head rank 5 is connected to the supply pipe 10, through which the liquefied gas from the unillustrated liquefied gas supplier is supplied. A predetermined quantity of the liquefied gas can be always stored by the liquid-level controller 11 that includes a liquid-level indicator and a liquid-level regulating valve. Herein, the configuration of the liquid-level controller 1 does not necessarily include a liquid-level indicator. For example, a thermocouple that detects the temperature of liquid nitrogen and controls a liquid-level can be used instead of a liquid-level indicator. In this way, any device can be used as long as it can control a liquid-Level.

In addition, to the head tank 5, the exhaust pipe 12 is connected, through which the evaporated liquefied gas is discharged outside the system.

To different five positions in a vertical direction of the outer pipe 2 of the heat exchanger 1, the respective return pipes 7, 7 . . . are connected. These return pipes 7, 7 . . . are connected to the main return pipe 9 through the on-off valves 8, 8 . . . and this main return pipe 9 is connected to the head tank 5.

Accordingly, the liquefied gas within the outer pipe 2 flows into the return pipes 7, 7 . . . and the on-off valves 8, 8 . . . with the bubbles formed by the evaporation of a part thereof, flows up in the main return pipe 9, and returns to the head tank 5. In addition, the liquefied gas that has returned to the head tank 5 flows into the liquefied gas supply pipe 6 again, and the liquefied gas is spontaneously circulated between the heat exchanger 1 and the head tank 5.

The entrance port 3a at the lower part of the inner pipe 3 of the heat exchanger 1 is connected to the hydrogen gas inflow pipe 13, and the exit port 3b at the upper part of the inner pipe 3 is connected to the hydrogen gas outflow pipe 14.

The hydrogen gas inflow pipe 13 has the function of flowing a hydrogen gas to be cooled into the inner pipe 3 of the heat exchanger 1, and is equipped with the flow rate controller that includes the flowmeter 15 and the flow rate-regulating valve 16, so as to control the flow rate of the hydrogen gas that is flowed into the inner pipe 3.

The hydrogen gas outflow pipe 14 has the function of supplying the hydrogen gas cooled in the heat exchanger 1 to an outside hydrogen automobile, etc. The hydrogen gas outflow pipe 14 is equipped with the thermometer 17 to measure the temperature, the pressure gauge 18 to measure the pressure, and the pressure transmitter 19.

The hydrogen gas temperature signal from the thermometer 17 is sent to the flow rate-regulating valve 20 provided to the hydrogen gas inflow pipe 13, so as to control the flow rate of the hydrogen gas, which is flowed into the inner pipe 3 of the beat exchanger 1, on the basis of the temperature of the hydrogen gas that flows in the hydrogen gas outflow pipe 14.

Furthermore, there is provided the bypass pipe 21 that directly connects the hydrogen gas inflow pipe 13 and the hydrogen gas outflow pipe 14. This bypass pipe 21 is configured to be parallel to the inner pipe 3 of the heat exchanger 1, and a part of the hydrogen gas that flows in the hydrogen gas inflow pipe 13 flows through the bypass pipe 21 directly into the hydrogen gas outflow pipe 14.

The bypass pipe 21 is equipped with the flow rate-regulating valve 22. The opening of the flow rate-regulating valve 22 is controlled on the basis of the hydrogen gas temperature signal from the thermometer 17, so as to regulate the flow rate of the hydrogen gas that flows in the bypass pipe 21.

Next the operation method of the aforementioned hydrogen gas-cooling device is described.

The hydrogen gas with a temperature of 0 to 40° C. and a pressure of 0 to 70 MPa is introduced from the hydrogen gas inflow pipe 13, and is flowed into the inner pipe 3 of the heat exchanger 1 after the flow rate thereof was regulated by the flow rate-regulating valve 16.

Meanwhile, the liquefied gas such as liquid nitrogen is supplied from the head tank 5 through the liquefied gas supply pipe 6 into the outer pipe 2 of the heat exchanger 1, and is stored in the outer pipe 2.

The hydrogen gas that is supplied into the inner pipe 3 of the beat exchanger 1 flows in the inner pipe 3, and is cooled by the contact with the wall surface thereof. Then, the hydrogen gas is withdrawn from the hydrogen gas outflow pipe 14 as the cooled hydrogen gas with a temperature of −40 to −30° C. and a pressure of 0 to 70 MPa, and is supplied to a hydrogen automobile, etc.

The liquefied gas with the outer pipe 2 of the heat exchanger 1 is heated by cooling the hydrogen gas, and a part thereof is evaporated and forms bubbles, to thereby form the state in which the bubbles are mixed with the liquefied gas.

This liquefied gas with the bubbles has a small apparent density, and flows up in the outer pipe 2, further flows up in the main return pipe 9 trough the return pipes 7, 7 . . . and the on-off valves 8, 8 . . . , and returns to the head tank 5. The evaporated liquefied gas (i.e. gas) within the liquefied gas that has returned to the head tank 5 is separated herein, and is discharged through the exhaust pipe 12. The liquefied gas is stored in the head tank 55 and is reused.

During this operation, the temperature of the cooled hydrogen gas that flows in the hydrogen gas outflow pipe 14 is monitored by the thermometer 17. When the temperature is deviated from the desired temperature, the control signal from the thermometer 17 is sent to the flow rate-regulating valve 20 provided to the hydrogen gas inflow pipe 13 and the flow rate-regulating valve 22 provided to the bypass pipe 21 and the openings of the flow rate-regulating valves 20 and 22 are regulated so as to change the flow rate of the uncooled hydrogen gas that flows in the hydrogen gas inflow pipe 13 or the bypass pipe 21. In this way, the cooled hydrogen gas with the desired temperature can be obtained.

In addition, by opening or closing the on-off valves 8, 8 . . . of the five return pipes 7, 7 . . . that are provided to the outer pipe 2 of the heat exchanger 1, it is possible to change the liquid-level of the liquefied gas that is stored in the outer pipe 2. This change of the liquid-level leads to the change of the contact area (i.e. effective heat-transfer area) of the inner pipe, and the liquefied gas. As a result, the degree of cooling of the hydrogen gas that flows in the inner pipe 3 changes, and therefore, it is possible to control the temperature of the cooled hydrogen gas that flows out to the hydrogen gas outflow pipe 14.

The respective temperatures of the outer pipe 2 and the inner pipe 3 of the heat exchanger 1 chance by the storage, discharge, and inflow of the liquefied gas, etc, and the lengths in the directions of the pipe axes are elongated or contacted by the temperature changes. These elongation and contraction are canceled by the bellows 4. Therefore, the problem such as the damage of the heat exchanger 1, which is attributed to the elongation and contraction of the outer pipe 2 and the inner pipe 3, does not occur.

In this cooling device, the temperature control of the cooled hydrogen gas can be performed by the three means of the flow rate-regulating valves 20, 22 and the return pipes 7, 7 . . . . Therefore, even when the flow rate of the hydrogen gas drastically changes, it is possible to always keep the temperature of the cooled hydrogen gas within the desired temperature range.

In the present embodiment, the number of the return pipe 7 that is connected to the outer pipe 2 of the heat exchanger 1 is set to five. However, this number is not limited to five, and may be one. As this number is large, it is possible to perform the precise temperature control of the cooled hydrogen gas.

### INDUSTRIAL APPLICABILITY

A hydrogen gas-cooling device of the present invention is industrially useful because facilities can be downsized, the consumption quantity of a refrigerant such as liquid nitrogen can be reduced, and the starting time and the termination time of the device can be shortened.

1. A hydrogen gas-cooling device comprising:
a heat exchanger that perform heat exchange between a hydrogen gas an liquefied gas to cool a hydrogen gas; and a head tank that stores the liquefied gas supplied to the heat exchanger, wherein
the heat exchanger has double pipe structure in which the hydrogen gas flows in an inner pipe, an outer pipe is filled with the liquefied gas, the pipe axis of the double pipe structure is vertically or obliquely arranged, a liquefied gas supply pipe that supplies the liquefied gas from the head tank is connected to a bottom part of the outer pipe, and a return pipe that returns the liquefied gas to the head tank is provided at a position upper than the bottom part of the outer pipe, and
the bottom of part of the head tank is positioned upper than a top part of the heat exchanger.

2. A hydrogen gas-cooling device according to claim 1, wherein two or more of the return pipes are provided at different positions in a vertical direction of the outer pipe.

3. A hydrogen gas-cooling device according to claim 1, wherein a part of the outer pipe of the heat exchanger forms bellows.

4. A hydrogen gas-cooling device according to claim 1, wherein a bypass pipe is provided in parallel with the inner pipe of the heat exchanger.
